(19) United States
(12) Patent Application Publication
(10) Pub. No.: US 2018/0161887 A1
(43) Pub. Date: Jun. 14, 2018

(54) ACTUATOR FOR A POWER TOOL

(71) Applicant: Think & Tinker Ltd., Palmer Lake, CO (US)

(72) Inventor: Ronal Reed, Monument, CO (US)

(73) Assignee: Think & Tinker Ltd., Palmer Lake, CO (US)

(21) Appl. No.: 15/832,338

(22) Filed: Dec. 5, 2017

Related U.S. Application Data
(60) Provisional application No. 62/431,960, filed on Dec. 9, 2016.

(51) Int. Cl. B23B 31/00; B23B 31/12; B23B 31/20; B23B 31/36

(52) U.S. Cl. CPC B23B 31/001; B23B 31/1238; B23B 2260/07; B23B 31/36; B23B 2231/201; B23B 31/208

(57) ABSTRACT

An actuator for use with a power tool is disclosed. The power tool includes a spindle-chuck body defining a tool axis and a collet nut surrounding the tool axis and rotatable about the tool axis. The collet nut is coupled to the spindle-chuck body. The actuator comprises a holder positionable to engage the spindle-chuck body and an actuation assembly including a first member positioned to engage the collet nut when the holder engages the spindle-chuck body and a second member operatively coupled to the first member to rotate the first member about a first axis. The second member is rotatable about a second axis non-parallel to the first axis.

### CROSS-REFERENCE TO RELATED APPLICATIONS

The present application claims priority to U.S. Provisional Patent Application Ser. No. 62/431,960, filed Dec. 9, 2016, and entitled “ACTUATOR FOR A POWER TOOL,” the complete disclosure of which is expressly incorporated by reference herein.

### BACKGROUND OF THE DISCLOSURE

The present application relates to an actuator for a power tool and, more particularly, to a device for assembling a drill bit or other tool component with a power tool.

Power tools, such as routers and spindles which may be used with router tables and CNC machines, typically incorporate a collet chuck system configured to couple with a shank end of a drill bit or other tool component. The drill bit or other tool is then operably coupled to a lower end of a rotating shaft which is driven by a motor. The rotating shaft may be identified as a spindle. More particularly, the bit may be operably coupled to the spindle through the collet chuck system. For example, a collet is installed within a bore on the distal end of the spindle, thereby defining a spindle-chuck, and the shank end of the bit may be coupled with the collet. As such, the bit is configured to rotate with the rotating shaft of the spindle.

The collet is retained in the spindle-chuck bore by a collet nut which threads onto the outside of the spindle-chuck. The collet nut generally surrounds a portion of the collet and provides the necessary force to allow the bit to be securely fixed within the bore. In order for the operator to assemble a bit with the spindle-chuck, the operator may need to use tools, such as one or more wrenches. For example, one wrench may hold the spindle-chuck to prevent rotation thereof when inserting the bit into the spindle-chuck and the second wrench may engage the collet nut to tighten or loosen the collet nut in order to couple the bit to the spindle-chuck or to remove the bit therefrom. However, because the operator may be required to use both hands simultaneously when installing or removing the bit from the spindle-chuck, this process of assembling the bit with the spindle-chuck may be inefficient as the operator may need to loosen the collet nut sufficiently, set the wrenches down, install and zero the bit, then pick up the wrenches, reposition the wrenches on the spindle-chuck and the collet nut, and attempt to apply the torque to the collet nut, during which the bit may change position or fall out of the collet completely. In addition, the force required to properly clamp the collet may be considerable and direct application of torque by two wrenches can be difficult and/or lead to operator injury or damage to the collet assembly.

Additionally, some power tools may use custom collet systems to assemble a bit to the tool. However, by customizing the collet system to only the single tool, added manufacturing steps and costs may be required and the collet system cannot be used for assembling a bit with additional tools.

Therefore, there is a need for a device or system which may allow the operator to assemble a bit to the tool with a single hand. Additionally, there is a need for a collet system that does not require a custom spindle assembly.

### SUMMARY OF THE DISCLOSURE

In one embodiment, an actuator for use with a power tool is disclosed. The power tool includes a spindle-chuck body defining a tool axis and a collet nut surrounding the tool axis and rotatable about the tool axis. The collet nut is coupled to the spindle-chuck body. The actuator comprises a holder positionable to engage the spindle-chuck body and an actuation assembly including a first member positioned to engage the collet nut when the holder engages the spindle-chuck body and a second member operatively coupled to the first member to rotate the first member about a first axis. The second member is rotatable about a second axis non-parallel to the first axis.

In another embodiment, an actuator for use with a power tool is disclosed. The power tool has a spindle-chuck body defining a tool axis, a collet surrounding the tool axis and rotatable about the tool axis, and a collet nut surrounding the collet. The collet and the collet nut are coupled to the spindle-chuck body. The actuator comprises a housing separable from the power tool, at least one retention member coupled to the housing and positionable to maintain a stationary position of at least one of the spindle-chuck body or the collet nut, and an actuation assembly rotatably coupled to the housing. The actuation assembly includes a first member positioned to engage the collet nut when the at least one retention member maintains the stationary position of the chuck body, a second member rotatably engaged with a portion of the first member to rotate the first member about a first axis, and a third member rotatably engaged with a portion of the second member to rotate the second member about a second axis.

The actuator or collet system or device or the present disclosure may allow for a bit to be installed on a power tool using a standard collet chuck without the need for multiple wrenches or custom spindle-chuck components. Additionally, an operator may use the actuator of the present disclosure to assemble a bit to a power tool using only one hand.

In one embodiment, the actuator of the present disclosure may comprise a rotatable shaft attached to a head of a spindle wrench provided by the operator. The actuator is configured to engage the collet assembly to tighten or loosen the collet nut to retain or loosen a bit therein. The rotatable shaft may have a cylindrical shaft extension which extends along a longitudinal axis from the spindle wrench head and provides the user with a handle which can be grasped and rotated about the longitudinal axis with only one hand. The rotational force is transferred from the rotatable shaft to the collet nut by a series of transfer members, gears, and/or power applicators. Meanwhile, the spindle may be held in place and inhibited from rotating by the actuator. The spindle and collet nut assemblies may include flat engagement surfaces, circular engagement surfaces, or any other type of engagement surface configured to engage with the actuator in order to inhibit the spindle from rotating when assembling a bit to the collet. More particularly, various engagement surfaces may be machined or otherwise formed on a spindle-chuck body of the spindle assembly and the actuator may engage the engagement surface(s) to prevent rotation of various portions of the spindle-chuck body. As the collet nut is tightened and loosened by the rotation of the rotatable shaft, the spindle-chuck body is held in place by the actuator so that an operator's other hand is free to hold the bit in the collet or perform other activities.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The foregoing aspects and many of the intended advantages of this invention will become more readily appreciated as the same becomes better understood by reference to the following detailed description when taken in conjunction with the accompanying drawings.

FIG. 1 is a front perspective view of an actuator for use with a collet assembly of a power tool;

FIG. 2 is an exploded view of the actuator of FIG. 1;

FIG. 3A is a cross-sectional view of the collet assembly of the power tool;

FIG. 3B is an exploded view of the collet assembly of FIG. 3A;

FIG. 4 is a side perspective view of an actuation assembly of the actuator of FIG. 1;

FIG. 5 is a front perspective view of a holder of the actuator of FIG. 1;

FIG. 6 is a side perspective view of the actuator of FIG. 1 engaged with the collet assembly of FIGS. 3A and 3B; and

FIG. 7 is a side perspective view of an underside of the actuator of FIG. 1 engaged with the collet assembly of a power tool.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplifications set out herein illustrate embodiments of the invention, and such exemplifications are not to be construed as limiting the scope of the invention in any manner.

### DETAILED DESCRIPTION OF THE DRAWINGS

For the purposes of promoting an understanding of the principals of the invention, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. It will be understood that no limitation of the scope of the invention is thereby intended. The invention includes any alterations and further modifications in the illustrative devices and described methods and further applications of the principles of the invention which would normally occur to one skilled in the art to which the invention relates.

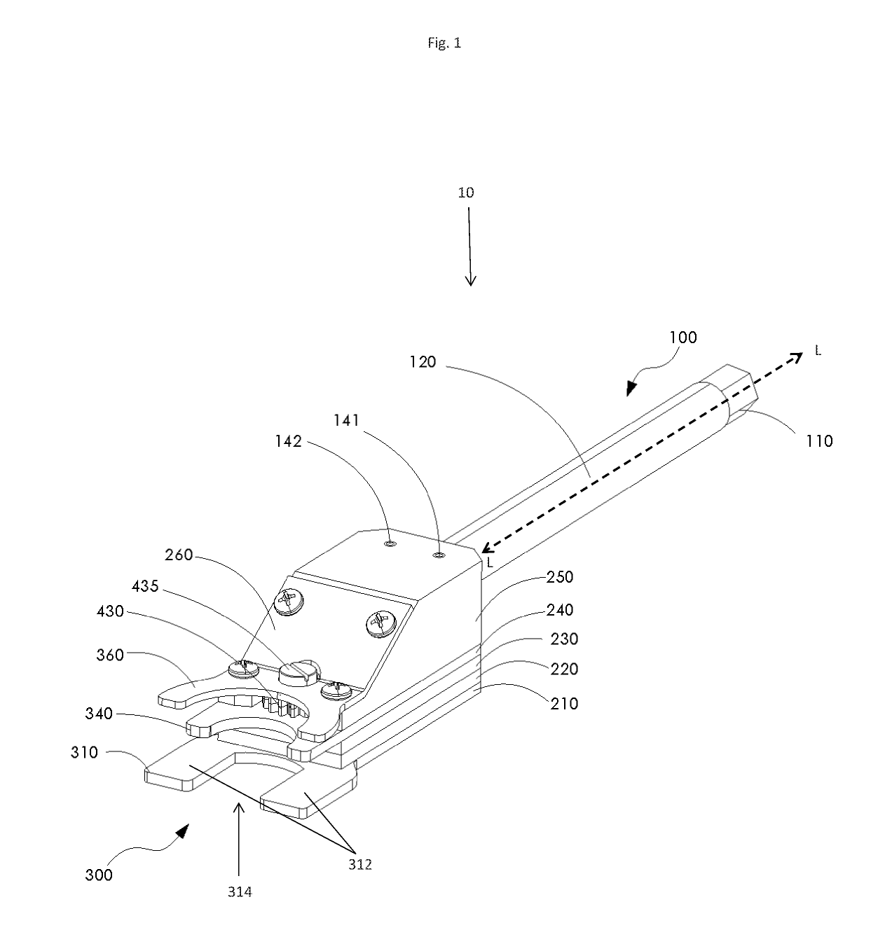

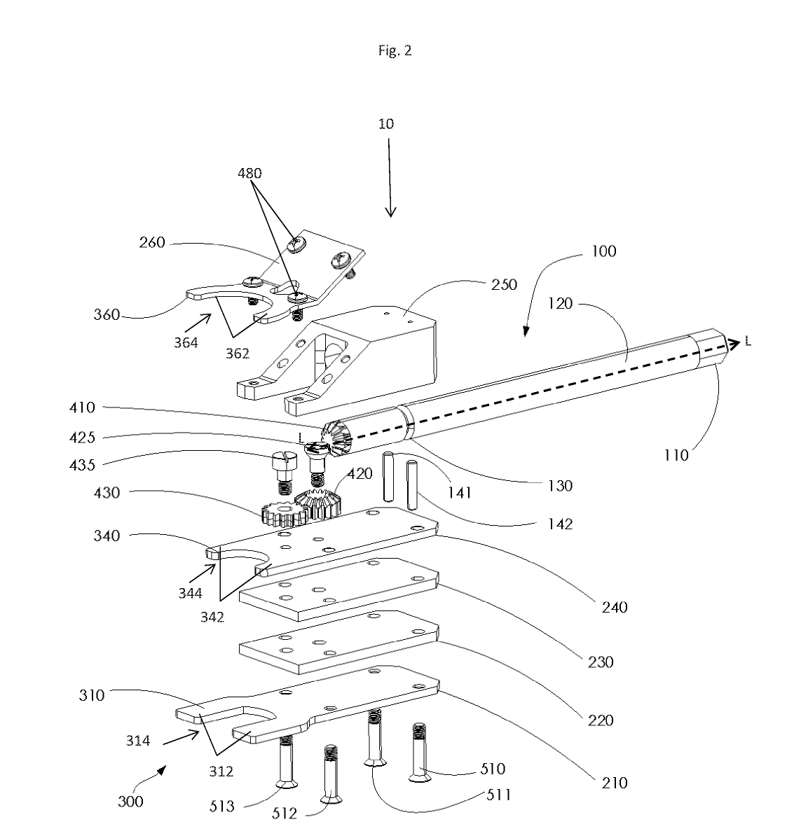

Referring to FIGS. 1 and 2, an actuator 10 for engaging a spindle and collet assembly of a power tool is shown. In one embodiment, actuator 10 is illustratively a one-handed spindle wrench. Actuator 10 includes a rotatable shaft 100 which may have a shaft extension 120 extending along a longitudinal axis L and rotatable about longitudinal axis L. Shaft 100 may be circular, polygonal, hexagonal, or any other shape in cross-section. Shaft 100 further includes a drive interface 110 which may include a port or an opening through which a handle or extension shaft may be inserted to provide the operator with additional leverage or rotational force when operating actuator 10. More particularly, drive interface 110 defines a built-in location for the operator to apply a secondary wrench or other device to actuator 10 if a particular collet of the power tool is stuck or otherwise requires more force than the user can impart on shaft 100.

Actuator 10 further includes an actuation assembly 102 which includes a first member 410, a second member 420, and a third member 430. First member 410 may be integrally formed with or coupled to shaft extension 120. First member 410 is configured to rotate with shaft extension 120 around longitudinal axis L (FIG. 1). Illustratively, first member 410 may be defined as a bevel gear or other end component having a plurality of teeth or grooves and protrusions configured to engage second member 420. In one embodiment, shaft 100, drive interface 110, and first member 410 may be integrally formed together, however, in alternative embodiments, shaft 100 may be comprised of multiple components coupled together to define the shaft, drive interface, and first member.

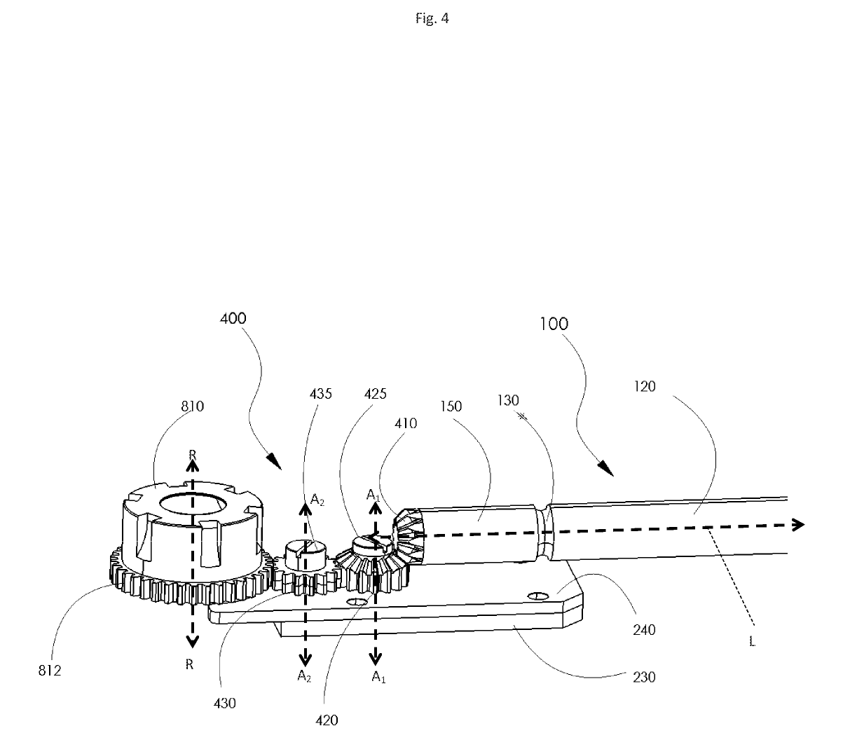

Second member 420 also may be defined as an idler gear having a plurality of teeth or grooves and protrusions. The teeth of second member 420 are configured to mesh or otherwise engage with the teeth of first member 410 such that the rotation of first member 410 about longitudinal axis L causes rotation of second member 420. However, second member 420 is configured to rotate about a second axis A₁ (FIG. 4) which is non-parallel, illustratively generally perpendicular, to longitudinal axis L. Second member 420 may be coupled to a portion of actuator 10 with a fastener 425, illustratively a threaded fastener, such as a shoulder screw.

Second member 420 is positioned laterally adjacent third member 430 in the direction of longitudinal axis L (FIG. 1) such that second member 420 is positioned intermediate first member 410 and third member 430 in the direction of longitudinal axis L. Illustratively, third member 430 may define a pinion gear having a plurality of teeth or grooves and protrusions which mesh or engage with the teeth of second member 420. As such, the rotation of second member 420, caused by first member 410 and the rotation of shaft 100, causes rotation of third member 430. As with second member 420, third member 430 is configured to rotate about a third axis A₂ which is non-parallel, and illustratively generally perpendicular, to longitudinal axis L but is parallel to first axis A₁. Third member 430 may be coupled to a portion of actuator 10 with a fastener 435, illustratively a threaded fastener, such as a shoulder screw.

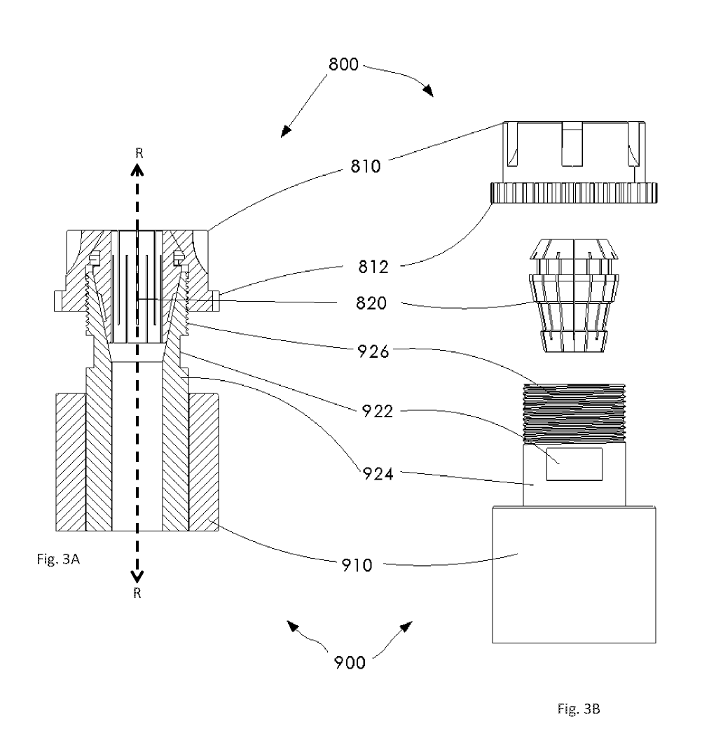

Referring to FIGS. 3A-4, actuation assembly 102 and, in particular, third member 430, is configured to engage a fourth member 812 on a collet assembly 800 of a power tool. More particularly, fourth member 812 may be laterally offset from second and third members 420, 430 in the direction of longitudinal axis L (FIG. 1). Collet assembly 800 includes a collet 820, a collet nut 810, and fourth member 812, illustratively a collet nut bull or gear, and is operably coupled to a spindle assembly 900 which includes a spindle motor 910 and a spindle-chuck body 924. Collet nut 810 may be formed with fourth member 812 such that fourth member 812 defines a plurality of spur teeth or cogs extending outwardly from the circumference of collet nut 810. In one embodiment, fourth member 812 is integrally formed with a body of collet nut 810. In an alternative embodiment, fourth member 812 is removably coupled to the body of collet nut 810.

Collet and spindle assemblies 800, 900 are operably coupled to a power tool, such as a drill (not shown), and are configured to retain a bit or other tool within collet 820. In one embodiment, collet 820 is a spring collet configured to be adjusted between a plurality of positions to retain the shank end of a bit or tool therein. For example, to retain a bit or tool within collet 820, collet nut 810 is rotated about a rotation axis R (FIG. 3A) of the tool. However, it can be difficult for an operator to position the bit within collet 820 and rotate collet nut 810 without using both hands to do so. Yet, at times, it may be necessary for the operator to have a free hand available for holding other tools or performing other tasks simultaneously. Therefore, as disclosed herein, actuator 10 is configured for use with collet and spindle assemblies 800, 900 to assist the operator with securing or releasing a bit or tool from collet 820 with only one hand.

As shown in FIG. 4, shaft 100 is configured to operably couple with actuation assembly 102 such that longitudinal axis L of shaft 100 is generally perpendicular to rotational axis R of the power tool. Additionally, longitudinal axis L of shaft 100 also is generally perpendicular to rotation axis A₁ of second member 420 and rotational axis A₂ of third member 430. Illustratively, rotational axes A₁, A₂ may be parallel with rotational axis R of the tool. When first member 410 of shaft 100 is in contact with second member 420, shaft 100 is configured to rotate both first and second members 410, 420 due to the meshing of the teeth of first and second members 410, 420. Additionally, second member 420 meshes with the teeth of third member 430 such that the rotation of shaft 100 also transfers rotation to third member 430. As is also shown in FIG. 4, third member 430 meshes with fourth member 812 such that rotation of shaft 100 also transfers rotation to collet nut 810. When collet nut 810 rotates, collet 820 closes or opens relative to the bit positioned therein to retain or release the bit therein. Additionally, because the operator merely needs to use one hand to rotate shaft 100, the operator's other hand is freely available to hold the bit or other tools during this process.

Alternatively, actuation assembly 102 may include less or more than four members. For example, in one embodiment, second member 420 may be configured to mesh directly with fourth member 812 without utilizing third member 430. However, the combination second and third members 420, 430 may advantageously allow the rotation of collet nut 810 to maintain the same rotation as shaft 100 during use of actuator 10 such that, for example, a clockwise turn of shaft 100 produces a clockwise turn of collet nut 810, each as viewed from the appropriate plane, thereby intuitively producing a tightening action of collet nut 810 as the operator expects regardless of the orientation of spindle assembly 900.

Referring to FIGS. 1, 2, and 5-7, while the user is rotating shaft 100, actuator 10 also may be used to stabilize or maintain the position of collet and/or spindle assemblies 800, 900. More particularly, actuator 10 includes a spindle-chuck engagement assembly 300 which is configured to removably engage components of collet and spindle assemblies 800, 900 to inhibit rotation of spindle-chuck body 924. Spindle-chuck engagement assembly 300 includes a first alignment plate 210 which defines an upper surface of actuator 10 and is configured to engage spindle-chuck body 924, a second alignment plate 240 positioned vertically below first alignment plate 210 and configured to engage a threaded portion 926 of spindle-chuck body 924, and a third alignment plate 260 positioned vertically below second alignment plate 240 and configured to engage collet nut 810.

More particularly, and as shown in FIG. 2, first alignment plate 210 includes an extension portion 310 which protrudes beyond the working face of actuator 10, where “working face” refers to the portion of actuator 10 configured to interface with collet nut 810 (or collet assembly 800). Extension portion 310 includes parallel arms 312 spaced apart by an opening or recess 314 positioned therebetween. In one embodiment, recess 314 has a generally rectangular shape defined by planar or linear engagement surfaces of arms 312. Spindle-chuck body 924 is positioned within recess 314 such that arms 312 flank opposing sides of spindle-chuck body 924 to inhibit rotation thereof. In one embodiment, spindle-chuck body 924 includes at least one retention feature, illustratively flat or planar surfaces 922, along the outer surface of spindle-chuck body 924. Surfaces 922 of spindle-chuck body 924 are configured to engage with the planar surfaces of arms 312 such that arms 312 contact surfaces 922 in a manner that frictionally retains spindle-chuck body 924 in a fixed position. In a further embodiment, the retention features of spindle-chuck body 924 and/or first alignment plate 210 may be tabs, grooves, or any feature configured to maintain spindle-chuck body 924 in a fixed position.

Similarly, and as shown in FIG. 2, second alignment plate 240 is provided with second extension portion 340 that generally surrounds a portion of threaded portion 926 of spindle-chuck body 924 and positions actuation assembly 102 of actuator 10 to interface with fourth member 812 of collet nut 810. The alignment of threaded portion 926 with second extension portion 340 ensures threaded portion 926 remains fixed while collet 820 is adjusted to secure or release a tool or bit. In one embodiment, second extension portion 340 includes arms 342 spaced apart by a recess or opening 344 which may have a generally semi-circular shape. Threaded portion 926 is positioned within recess 344 such that arms 342 flank opposing sides of threaded portion 926 which may inhibit rotation thereof.

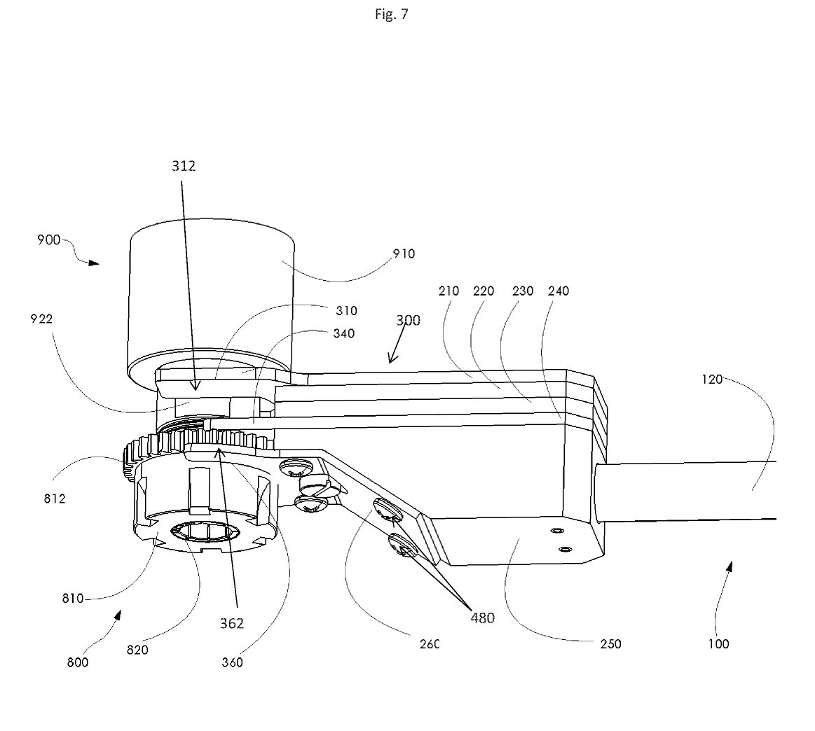

Additionally, and as shown in FIG. 2, third alignment plate 260 is also provided with a third extension portion 360 which includes arms 362 spaced apart by a semi-circular recess or opening 364. Arms 362 are configured to generally surround a portion of collet nut 810, as shown in FIG. 7. In this way, third alignment plate 260 is configured to align with collet nut 810 while collet 820 is being opened or closed to release or secure a bit therein.

The spacing and orientations of alignment plates 210, 240, 260 is configured such that the teeth of the fourth member 812 are positioned between second and third alignment plates 240 and 260, as shown in FIG. 7, so that third member 430 of actuation assembly 102 aligns with fourth member 812. When third and fourth members 430, 812 are aligned, actuator 10 is in planar alignment with fourth member 812. In general, first, second, and third alignment plates 210, 240, 260 facilitate alignment of actuator 10 with collect and spindle assemblies 800, 900 and prevent relative rotation of spindle-chuck body 924 during the application of torque to the system when shaft 100 is rotated.

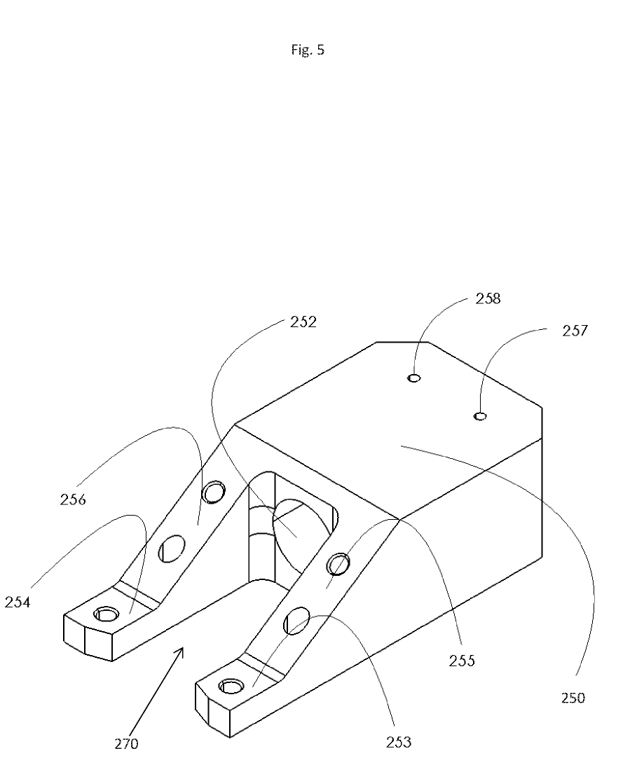

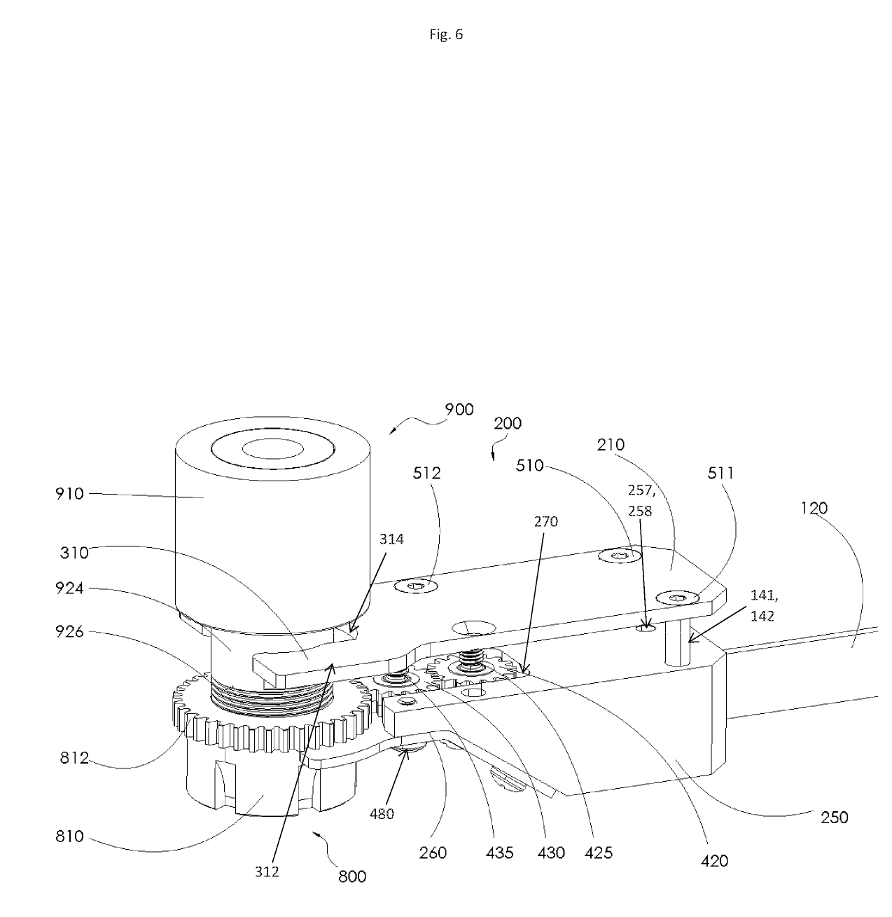

Referring to FIGS. 1, 2, and 5-7, to ensure proper alignment of actuation assembly 102 with collet and spindle assemblies 800, 900, actuator 10 may include a housing or holder and spacer plates to which first, second, and third alignment plates 210, 240, 260 are coupled, as disclosed herein. More particularly, as shown in FIG. 5, actuator 10 may include a housing or holder 250, illustratively a transfer case, configured to generally surround and protect first, second, and third members 410, 420, 430. In this way, housing 250 protects first, second, and third members 410, 420, 430 from damage, dirt, debris, or other environmental factors. Similarly, third alignment plate 260 also may provide protection to actuation assembly 102 from environmental factors, as shown in FIG. 6, because third alignment plate 260 conceals at least a portion of second, third, and fourth members 420, 430, 812.

As shown best in FIG. 6, housing 250 includes a recess or opening 270 into which at least second and third members 420, 430 are received. Opening 270 extends between extension arms 253, 254, which may have a generally rectangular shape, and angled portions 255, 256, which extend from extension arms 253, 254, respectively. In one embodiment, housing 250, including extension arms 253, 254 and angled portions 255, 256, defines a unitary body comprised of the same material, however, in alternative embodiments, housing 250 may be comprised of multiple components coupled together.

Additionally, as shown in FIG. 6, housing 250 receives shaft 100 through a bore 252 (FIG. 5), such that first member 410 is positioned internally within housing 250. Referring to FIGS. 2, 5, and 6, housing 250 includes openings 257, 258 (FIG. 5) which allow retention members 141, 142 to protrude into the diameter of bore 252 (FIG. 5). Retention members 141, 142 act to secure shaft 100 within bore 252. More particularly, in one embodiment, retention members 141, 142 define pins which may be received within a shaft retention groove 130 of shaft 100 (FIG. 2) and thereby secure shaft 100 within housing 250 while still allowing shaft 100 to freely rotate about longitudinal axis L (FIG. 1).

Additionally, housing 250 couples with second and third alignment plates 240, 260. Referring to FIGS. 1, 2, and 5-7, an underside of housing 250 couples with third alignment plate 260. More particularly, a plurality of fasteners 480 (e.g., screws, bolts) extend through openings on extension arms 253, 254 and angled portions 255, 256 and corresponding openings on third alignment plate 260 to fix third alignment plate 260 to housing 250. In this way, as shown in FIG. 6, third alignment plate 260 has an angled configuration such that a first portion of third alignment plate 260 is angled relative to longitudinal axis L (FIG. 1) to couple with angled portions 255, 256 and a second portion of third alignment plate 260 is generally planar to longitudinal axis L to couple with extension arms 253, 254.

Housing 250 also couples with second alignment plate 240 on an upper side of housing 250 using fasteners 510, 511, 512, 513 (e.g., screws, bolts) (FIG. 1). More particularly, second alignment plate 240 includes openings therein which align with openings on first alignment plate 210 (and the spacer plates disclosed further herein) to receive fasteners 510, 511, 512, 513 therethrough. As such, fasteners 510, 511, 512, 513 secure both first and second alignment plates 210, 240 and the spacer plates to an upper side of housing 250.

Referring to FIGS. 1, 2, and 7, actuator 10 includes one or more spacer plates to ensure proper alignment of actuation assembly 102 with fourth member 812 and proper alignment between first, second, and third alignment plates 210, 240, 260 with collet and spindle assemblies 800, 900. In the illustrative embodiments of FIGS. 1, 2, and 7, actuator 10 includes a first spacer plate 220 and a second spacer plate 230. Spacer plates 220, 230 are coupled to each other and first and second alignment plates 210, 240 with fasteners 510, 511, 512, 513 and are positioned vertically intermediate first and second alignment plates 210, 240 to provide sufficient separation between first and second alignment plates 210, 240 for alignment with spindle-chuck body 924 and collet nut 810. In one embodiment, actuator 10 may include less or more than two spacer plates and/or the thickness of spacer plates 220, 230 may be adjusted to accommodate various spacings between surfaces 922 of spindle-chuck body 924 and collet nut 810. For example, a single spacer plate with a greater thickness may be used to reduce the overall part count of actuator 10, however, a plurality of spacer plates with the same or varying thicknesses also may be provided for greater flexibility to accommodate various power tools from multiple manufacturers.

In operation, the operator aligns actuator 10 with a power tool and, more particularly, with collet and spindle assemblies 800, 900 of the power tool. To ensure proper alignment, first alignment plate 210 is positioned against surfaces 922 of spindle-chuck body 924, second alignment plate 240 is positioned against threaded portion 926 of spindle-chuck body 924, and third alignment plate 260 is positioned against collet nut 810, as shown in FIG. 6. The contact between spindle chuck-body 924, collet nut 810, and alignment plates 210, 240, 260 ensures that actuation assembly 102 of actuator 10 also is properly aligned such that illustrative third member 430 contacts fourth member 812 of collet assembly 800. Actuator 10 may be used with a plurality of power tools and spacer plates 220, 230 may be used to accommodate different sizes or configurations of various power tools.

Once actuator 10 is aligned with collet and spindle assemblies 800, 900 of the power tool, the operator may position a bit or other tool within the central bore of opening of collet 820 (FIG. 3A). The operator then rotates shaft 100, using only one hand, which causes first member 410 to rotate. The rotational force of the operator turning shaft 100 is transferred from first member 410 to second member 420, and then to third member 430 from second member 420, and ultimately to fourth member 812 on collet nut 810 from third member 430. Internal threads inside collet nut 810 cause collet 820 to tighten or loosen relative to the bit or tool positioned therein because the rotation of fourth member 812 causes collet nut 810 to rotate relative to threaded portion 926 of spindle-chuck body 924. This rotation of collet nut 810 causes collet 820 to be compressed or released relative to spindle-chuck body 924 which compresses or releases collet 820 radially around the shank of the cutting tool or bit present in the collet bore. As fourth member 812 rotates, collet nut 810 rotates with fourth member 812, however, spindle-chuck body 924 does not rotate with collet nut 810 because first and second alignment plates 210, 240 inhibit rotation of spindle-chuck body 924 due to at least the engagement between planar surface of arms 312 of first alignment plate 210 against surfaces 922 of spindle-chuck body 924.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practices in the art to which this invention pertains.

What is claimed is:

1. An actuator for use with a power tool having a spindle-chuck body defining a tool axis and a collet nut surrounding the tool axis and rotatable about the tool axis, the collet nut being coupled to the spindle-chuck body, the actuator comprising:
a holder positionable to engage the chuck body; and
an actuation assembly including a first member positioned to engage the collet nut when the holder engages the spindle-chuck body and a second member operatively coupled to the first member to rotate the first member about a first axis, and the second member being rotatable about a second axis non-parallel to the first axis.

2. The actuator of claim 1, wherein the holder includes an opening configured to receive the spindle-chuck body.

3. The actuator of claim 1, wherein the holder has a first planar engagement surface adapted to contact a second planar engagement surface of the chuck body to prevent rotation of the chuck body.

4. The actuator of claim 1, wherein the holder is configured to maintain a stationary position of the spindle-chuck body and the actuation assembly is configured to adjust a position of a collet operably coupled to the collet nut relative to the spindle-chuck body.

5. The actuator of claim 1, wherein the first axis is parallel to the tool axis and the second axis is perpendicular to the tool axis.

6. The actuator of claim 1, wherein the actuation member includes a third member positioned to engage the first and the second member.

7. The actuator of claim 6, wherein the third member is rotatable about a third axis, and the second axis is non-parallel to the third axis.

8. The actuator of claim 7, wherein first member defines a first gear having a first plurality of teeth, the second member defines a rotatable shaft, and the third member defines a second gear having a second plurality of teeth configured to engage the first plurality of teeth and the rotatable shaft.

9. The actuator of claim 8, wherein the first and second gears are laterally aligned in a direction perpendicular to the tool axis.

10. The actuator of claim 1, wherein the holder is configured to removably engage the collet nut of the power tool.

11. The actuator of claim 1, wherein the holder and the actuation assembly are separable from a housing of the power tool.

12. An actuator for use with a power tool having a spindle-chuck body defining a tool axis, a collet surrounding the tool axis and rotatable about the tool axis, and a collet nut surrounding the collet, the collet and the collet nut being coupled to the spindle-chuck body, the actuator comprising:
a housing separable from the power tool;
at least one retention member coupled to the housing and positionable to maintain a stationary position of the spindle-chuck body; and
an actuation assembly rotatably coupled to the housing and including a first member positioned to engage the collet nut when the at least one retention member maintains the stationary position of the spindle-chuck body, a second member rotatably engaged with a portion of the first member to rotate the first member about a first axis, and a third member rotatably engaged with a portion of the second member to rotate the second member about a second axis.

13. The actuator of claim 12, wherein the at least one retention member is configured to maintain the stationary position of the spindle-chuck body and allows rotation of the collet nut.

14. The actuator of claim 13, wherein the first member is a first gear configured to engage a gear surface of the collet nut, the second member is a second gear, the third member is rotatable shaft, and the first gear is positionable to engage the gear surface of the collet nut to rotate the gear surface about the tool axis.

15. The actuator of claim 12, wherein the first and second members are laterally offset from the collet nut in a direction perpendicular to the tool axis.

16. The actuator of claim 15, wherein the first member is positioned laterally intermediate the collet nut and the second gear in the direction perpendicular to the tool axis.

17. The actuator of claim 12, wherein the at least one retention member includes a first holder couple to the housing with a first opening to engage the spindle-chuck body and a second holder coupled to the housing with a second opening to receive the collet nut.

18. The actuator of claim 17, wherein the first and second holders are removably coupled to the housing.

19. The actuator of claim 17, further comprising a gear surface of the collet nut operatively coupled to the collet nut, and the gear surface is positioned intermediate the first and second holders when the housing engages the spindle-chuck body and the collet nut.

20. The actuator of claim 17, further comprising a gear surface of the collet nut integral with a body of the collet nut, and the gear surface is positioned intermediate the first and second holders when the housing engages the spindle-chuck body and the collet nut.

21. The actuator of claim of claim 17, wherein the first opening of the first holder is defined by first and second linear engagement surfaces, and the second opening of the second holder is defined by third and fourth curved engagement surfaces.
